(19) United States
(12) Patent Application Publication
(10) Pub. No.: US 2025/0321518 A1
(43) Pub. Date: Oct. 16, 2025

(54) IMAGE FORMING APPARATUS THAT ADJUSTS NUMBER OF SHEETS THAT ARE TO PASS THERETHROUGH

(71) Applicant: CANON KABUSHIKI KAISHA, Tokyo (JP)

(72) Inventors: TAKAHIRO UCHIYAMA, Shizuoka (JP); HIROHIKO AIBA, Shizuoka (JP)

(21) Appl. No.: 19/174,377

(22) Filed: Apr. 9, 2025

(30) Foreign Application Priority Data
Apr. 11, 2024 (JP) 2024-064117

(51) Int. Cl. G03G 15/20; G03G 15/00

(52) U.S. Cl. CPC G03G 15/2028; G03G 15/2064; G03G 15/657; G03G 2215/00413; G03G 2215/2025

(57) ABSTRACT

A second rotational member can be in contact with a first rotational member and forms a nip portion and conveys a sheet at a predetermined conveyance speed. A heating unit heats, via the first rotational member, the sheet on which a toner image has been formed. A control unit obtains a history value of an amount of toner to be transferred to an end region of each of a plurality of sheets that are consecutively conveyed. The end region extends in parallel with a conveyance direction of the plurality of sheets. The number of sheets to be heated per unit time is adjusted according to the history value.

### BACKGROUND

### Field of the Disclosure

The present disclosure relates to an image forming apparatus that adjusts the number of sheets that are to pass therethrough.

### Description of the Related Art

An electrophotographic fixing device heats a sheet and a toner image and fixes the toner image on the sheet. Since sizes of sheets are various, the width of the fixing device is designed so as to allow a sheet with a maximum assumed width to pass therethrough. Accordingly, when a sheet with a width narrower than the maximum width passes through the fixing device, a partial temperature rise occurs at ends in the width direction of the fixing device. This is referred to as a temperature rise in a non-passage region.

When a temperature rise in a non-passage region occurs and a fixing device is used while the temperature of an end is high, there is a possibility that the lifetime of components constituting the fixing device will decrease or that a problem will occur in conveyance of recording materials. Japanese Patent Laid-Open No. H08-305188 proposes increasing a feeding interval between a preceding sheet and a succeeding sheet and thereby suppressing a temperature rise in a non-passage region. Japanese Patent Laid-Open No. 2022-113367 proposes increasing throughput if the image printing ratio of end regions is 0% and decreasing throughput if the image printing ratio is not 0%. With this, a hot offset in end regions of an image is suppressed.

Temperatures of fixing devices have been increased with a recent increase in speed of image forming apparatuses. Accordingly, there is a need to increase the feeding interval not only for sheets with a narrow width but also for sheets with a wide width. When the feeding interval is increased, the number of heated sheets per unit time (number of processed sheets) decreases, and the productivity of the image forming apparatus decreases. In the method of Japanese Patent Laid-Open No. 2022-113367, the number of sheets to be processed per unit time for a respective sheet is set based on the image printing ratio of end regions of that sheet. However, since the image printing ratio of a preceding sheet is not taken into account, there are instances where the number of sheets to be processed per unit time is unnecessarily decreased.

### SUMMARY

The present disclosure provides an image forming apparatus comprising: an image forming unit configured to form a toner image on a sheet; a first rotational member; a second rotational member configured to be in contact with the first rotational member and form a nip portion and configured to convey the sheet at a predetermined conveyance speed; a heating unit configured to heat, via the first rotational member, the sheet on which the toner image has been formed; and a control unit configured to control the number of sheets to be heated per unit time by the heating unit. The control unit is configured to obtain a history value of an amount of toner to be transferred to an end region of each of a plurality of sheets that are consecutively conveyed, the end region extending in parallel with a conveyance direction of the plurality of sheets, and adjust the number of sheets to be heated per unit time according to the history value.

Further features of the present disclosure will become apparent from the following description of exemplary embodiments (with reference to the attached drawings).

### BRIEF DESCRIPTION OF THE DRAWINGS

FIG. 1 is a schematic cross-sectional view of an image forming apparatus.

FIG. 2 is a schematic cross-sectional view of a fixing device.

FIG. 3 is a diagram illustrating a conveyance position of a sheet and a position of a heater.

FIG. 4 is a diagram illustrating a controller.

FIG. 5 is a flowchart for explaining a control method of a first embodiment.

FIG. 6 is a diagram illustrating images formed in end regions.

FIG. 7A is a diagram illustrating an image printing ratio, a toner amount, and a saturation amount.

FIG. 7B is a diagram illustrating a relationship between a feeding interval and a correction coefficient.

FIG. 8 is a diagram illustrating history obtainment timings.

FIG. 9 is a diagram illustrating a relationship between consecutive printing time and a non-passage region temperature standard value.

FIGS. 10A and 10B are diagrams illustrating a temperature rise in a non-passage region and a contribution towards temperature decrease by toner formed in end regions.

FIG. 11 is a diagram illustrating print conditions.

FIG. 12A is a diagram illustrating a relationship between the number of printed sheets and a history value.

FIG. 12B is a diagram illustrating a relationship between the number of printed sheets and a temperature of a non-passage region.

FIG. 13 is a diagram illustrating a heat propagation model.

FIGS. 14A and 14B are diagrams illustrating an effect of a toner image formed in an end region on a non-passage region temperature for each size of a sheet.

FIG. 15 is a diagram illustrating a controller.

FIG. 16 is a flowchart for explaining a control method of a second embodiment.

FIG. 17 is a diagram illustrating division of end regions.

FIG. 18 is a diagram illustrating an index decision unit.

FIG. 19 is a flowchart for explaining a control method of a third embodiment.

FIG. 20 is a diagram illustrating test images.

FIG. 21 is a diagram illustrating a relationship between a test image and a non-passage region temperature.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### 1. First Embodiment

### 1-1. Image Forming Apparatus

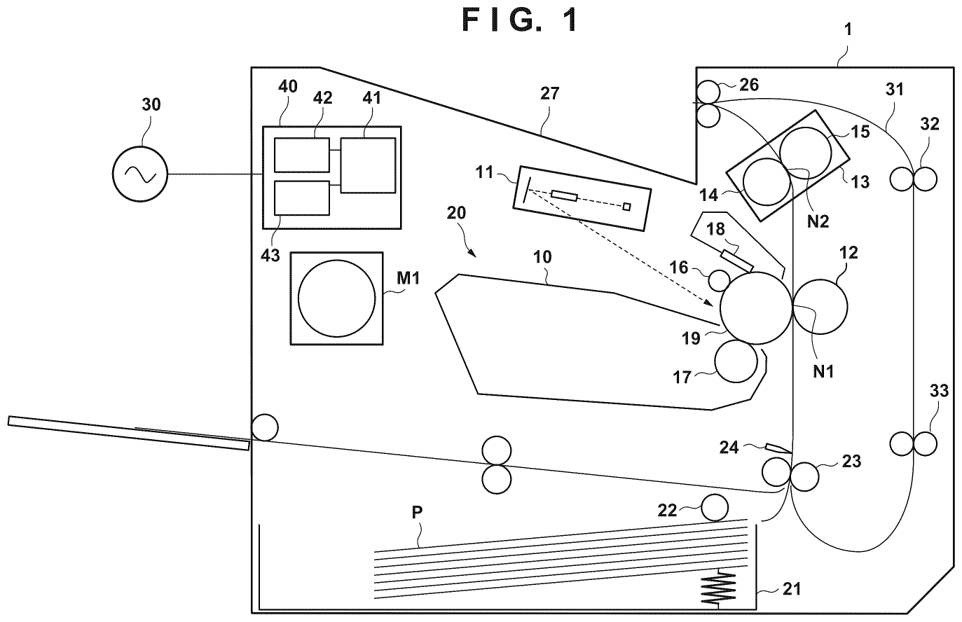

As illustrated in FIG. 1, an image forming apparatus 1 is a laser printer that forms an image on a sheet P by using an electrophotographic method. The image forming apparatus 1 may be implemented in a multifunction machine, a copy machine, or a facsimile apparatus. The sheet P may be referred to as a recording material, recording paper, or a transfer material. The image forming apparatus 1 operates by being supplied with power from an AC power source 30. An image forming unit 20 is formed by members such as in the following.

A photosensitive drum 19 is an image carrier (electrophotographic photosensitive member) that carries an electrostatic latent image and a toner image and rotates. A cleaning blade 18 cleans the surface of the photosensitive drum 19. A charging roller 16 is a charging member that charges the surface of the photosensitive drum 19. The charging roller 16 may be replaced with a charging wire. A laser scanner 11 irradiates a laser beam corresponding to an image signal onto the surface of the photosensitive drum 19 and forms an electrostatic latent image. A developing roller 17 develops an electrostatic latent image with toner held in a toner container in a process cartridge 10 and forms a toner image. The process cartridge 10 includes the photosensitive drum 19, the charging roller 16, the developing roller 17, and the cleaning blade 18. The photosensitive drum 19 rotates by being driven by a motor M1. With this, the toner image is conveyed to a transfer nip N1. The transfer nip N1 is a nip portion formed by contact between the photosensitive drum 19 and a transfer roller 12.

A feeding cassette 21 is a container for storing a plurality of sheets P. A feeding roller 22 is driven by being rotated by the motor M1 and feeds a sheet P to a conveyance path. A pair of conveyance rollers 23 are rotationally driven by the motor M1 and conveys the sheet P to the transfer nip N1.

A top sensor 24 is installed on a conveyance path between the pair of conveyance rollers 23 and the transfer nip N1 and detects a passing timing of the leading end of the sheet P fed by the pair of conveyance rollers 23. A controller 40 adjusts a write start timing of an electrostatic latent image by the laser scanner 11 according to the timing of the leading end of the sheet P detected by the top sensor 24. That is, the write start timing is controlled such that the leading end of the toner image on the photosensitive drum 19 reaches the transfer nip N1 at the timing when the leading end of the sheet P reaches the transfer nip N1. The controller 40 includes a CPU 41, a ROM 42, and a RAM 43. The CPU 41 executes various programs stored in the ROM 42 and thereby controls various operations pertaining to image formation while using the RAM 43 as a working region. The ROM 42 is a non-transitory storage medium that stores a control program of the image forming apparatus 1.

The toner image is transferred from the photosensitive drum 19 to the sheet P in the transfer nip N1. The sheet P is conveyed to a fixing device 13 by the photosensitive drum 19 and the transfer roller 12 rotating.

The fixing device 13 includes a fixing film 14 as a fixing member and a pressing roller 15 as a pressing member. The pressing roller 15 is rotationally driven by the motor M1. The fixing film 14 rotates by being driven by the pressing roller 15. The sheet P is conveyed while being held in a fixing nip N2 formed by contact between the pressing roller 15 and the fixing film 14. During that time, the temperature (fixing temperature) of the fixing film 14 is controlled by the CPU 41 so as to be the target temperature. By the toner image on the sheet P being heated by the fixing film 14, the toner image is fixed to the sheet P. The sheet P, which has passed through the fixing device 13, is conveyed to a pair of discharge rollers 26 that discharges the sheet P. The pair of discharge rollers 26 are rotationally driven by the motor M1 and discharges the sheet P to a discharge tray provided at an upper portion of the image forming apparatus 1.

In double-sided printing, the pair of discharge rollers 26 are switched from normal rotation to reverse rotation and thereby conveys the sheet P, on which an image is formed on a first surface, to a conveyance path 31 for double-sided printing. This is called switchback reversal and is a method of switching the image forming surface of the sheet P from the first surface to a second surface. Pairs of conveyance rollers 32 and 33 provided in the conveyance path 31 convey the sheet P and pass the sheet P to the pair of conveyance rollers 23. Then, an image is also formed on the second surface of the sheet P.

The image forming apparatus 1 is capable of printing, for example, a black and white image on A4-sized (210 mm×297 mm) plain paper at a conveyance speed of 240 mm/sec. This corresponds to a throughput of about 43 sheets/min. The image forming apparatus 1 may be capable of color printing or multi-color printing.

### 1-2. Fixing Device

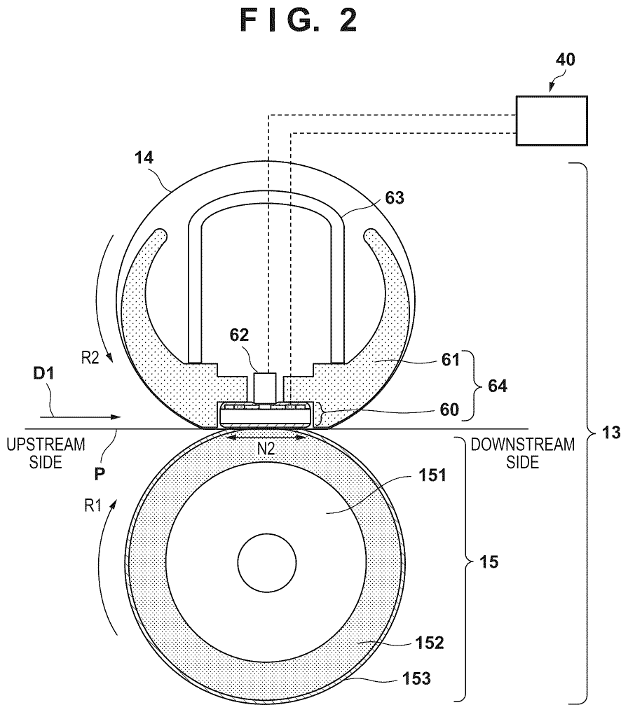

As illustrated in FIG. 2, the fixing device 13 includes the fixing film 14, the pressing roller 15, a nip forming member 64, and a pressing stay 63. The nip forming member 64 includes a heater 60 and a heater holder 61. An arrow D1 indicates the conveyance direction of the sheet P. An arrow R1 indicates the rotational direction of the pressing roller 15. An arrow R2 indicates the rotational direction of the fixing film 14.

The fixing film 14 is a flexible, tubular (endless), film-like member. The film thickness of the fixing film 14 may be, for example, 450 micrometers (um) or less and 20 μm or more. When the heat capacity of the fixing film 14 decreases, wait time (first printout time) shortens. A heat-resistant, single-layer film may be employed as the fixing film 14. Alternatively, a multilayer film may be employed as the fixing film 14. The multilayer film includes, for example, a film base layer and a coating layer. In the first embodiment, a film base layer constituted by a polyimide film and a coating layer constituted by perfluoroalkoxy alkane (PFA) are employed. The thickness of the film base layer is, for example, about 60 μm. The thickness of the coating layer is, for example, about 14 μm. The outer diameter of the fixing film 14 is, for example, 24 mm. A metal material such as stainless steel (SUS) may be used as the film base layer instead of resin materials. Further, in order to improve image quality, heat-resistant rubber such as silicone rubber may be formed between the film base layer and the coating layer.

The pressing roller 15 includes a core metal 151, an elastic layer 152, and a surface layer 153. The core metal 151 may be, for example, an aluminum core metal. The elastic layer 152 may be, for example, silicone rubber. The thickness of the surface layer 153 is, for example, about 50 μm, and a material thereof is PFA. The outer diameter of the pressing roller 15 may be, for example, 25 mm. The thickness of the elastic layer 152 may be, for example, about 3 mm.

The heater 60 is a plate-like heating member that rapidly heats the fixing film 14 while being in contact with the inner circumferential surface of the fixing film 14. The heater 60 has a plate-like shape with low heat capacity. The heater 60 may include a heat generating resistor layer and an insulating ceramic substrate. The ceramic substrate is formed by alumina or aluminum nitride. The heat generating resistor layer is formed by silver-palladium (Ag/Pd), ruthenium (IV) oxide (RuO2), or tantalum nitride (Ta₂N), or the like. A glass layer may be provided on heat generating resistor layer as an insulating protection layer. The temperature of the heater 60 is detected by a temperature sensor (thermistor 62) that is in contact with the back surface of the ceramic substrate.

The heater holder 61 is arranged inside the fixing film 14. The heater holder 61 holds the heater 60. The pressing stay 63 is constituted by a rigid member such as metal and applies pressure received from a spring (not illustrated) or the like to the pressing roller 15 through the heater holder 61. This pressure forms the fixing nip N2, which has a predetermined surface area, between the nip forming member 64 and the pressing roller 15.

In FIG. 2, the heater 60 is in direct contact with the inner circumferential surface of the fixing film 14, but this is only one example. A thermally conductive, plate-like or sheet-like member (e.g., a sheet-like member constituted by ferroalloy or aluminum material) may be arranged between the heater 60 and the fixing film 14. The heater 60 may heat the fixing film 14 through a sliding member that slides against the inner circumferential surface of the fixing film 14.

Upon input of a print signal from an external input device such as an image scanner or a host computer, the controller 40 controls the motor M1 and rotationally drives the pressing roller 15. The fixing film 14 is rotated by a rotational force being transmitted from the pressing roller 15 to the fixing film 14.

The controller 40 controls the power supplied from the AC power source 30 to the heater 60 and maintains the temperature detected by the thermistor 62 at the target temperature. A triac may be used for AC control.

When the fixing film 14 rotates by being driven by the pressing roller 15 and the temperature of the heater 60 reaches a predetermined target temperature, the sheet P to which the toner image has been transferred is conveyed to the fixing nip N2. By the sheet P being conveyed through the fixing nip N2, the heat of the heater 60 is applied to the sheet P through the fixing film 14. That is, the non-fixed toner image on the sheet P is heated and pressed and is fixed to the sheet P. The sheet P, which has passed through the fixing nip N2, is separated from the fixing film 14 and is further conveyed.

### 1-3. Temperature Rise in Non-Passage Region

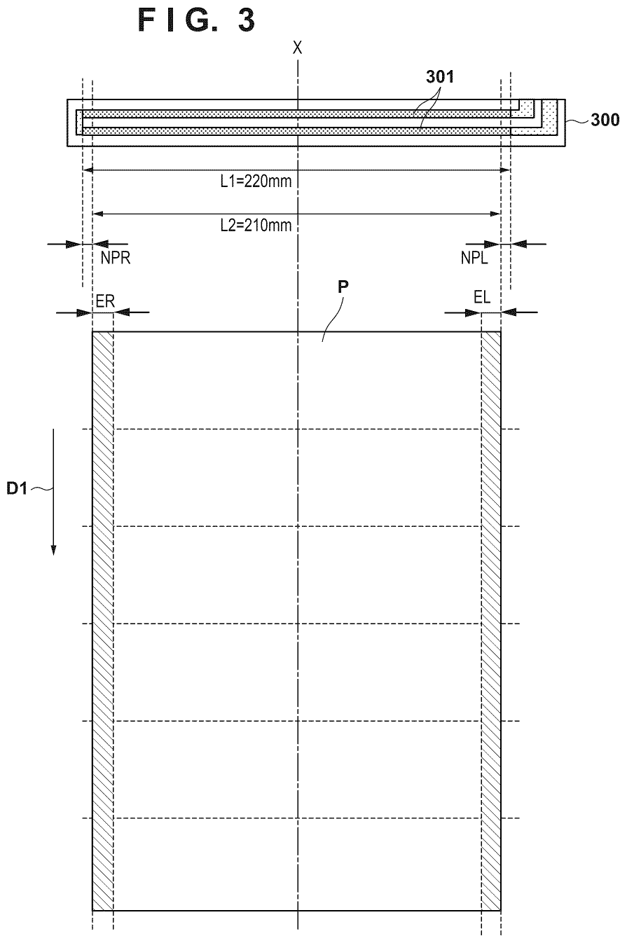

FIG. 3 illustrates a relationship between the heater 60 and the conveyance position of an A4-sized sheet P. Heating elements 301 are formed on a substrate 300. A width L1 of the heating elements 301 is 220 mm, which is a length corresponding to the maximum length (LTR size) of sheet P assumed in the design.

There are cases where an A4-sized sheet P (width L2=210 mm) passes through the fixing device 13. In this case, a region NPL (5 mm) from the left end of the heating elements 301 to the left end of the sheet P and a region NPR (5 mm) from the right end of the heating elements 301 to the right end of the sheet P do not come in contact with the sheet P through the fixing film 14. In the following, the regions NPL and NPR will be called non-passage regions. A region in the heating elements 301 that come indirectly in contact with the sheet P via the fixing film 14 is referred to as a passage region. The concept of a passage region and a non-passage region is applied to each of the heating elements 301, the fixing film 14, and the pressing roller 15.

When a toner image is consecutively formed on a plurality of A4-sized sheets P, the temperatures of non-passage regions NPL and NPR become higher than the temperature of the passage region. To maintain the temperature of the heater 60 at the target temperature, the same power is supplied throughout the heating elements 301. Heat generated in the passage region of the heating elements 301 is consumed in order to melt the toner. Meanwhile, heat generated in the non-passage regions of the heating elements 301 is not consumed in order to melt the toner. Therefore, although the temperature of the passage region is maintained at the target temperature, the temperatures of non-passage regions become higher than the target temperature. This is a phenomenon called a temperature rise in a non-passage region.

### 1-4. Block Diagram of Controller

As illustrated in FIG. 3, X indicates the center of the sheet P in the width direction. In this example, the center of the fixing device 13 in the width direction also coincides with X. Regardless of the width of the sheet P, the sheet P is conveyed such that the center of the sheet P coincides with the center of the fixing device 13. Therefore, the temperatures of non-passage regions NP of the fixing film 14 become higher than the temperature of the passage region.

Incidentally, the temperatures of non-passage regions NP are affected by the temperature of the passage region present more inward than the non-passage regions NP. The temperature of the passage region is affected by the amount of toner that has been applied to end regions E of the sheet P. When a toner image is consecutively formed on a plurality of sheets P, the temperatures of non-passage regions NP for when an i-th sheet P passes is cumulatively affected by the amounts of toner that have been applied to respective end regions E of first to i−1-th sheets P. Therefore, the CPU 41 accumulates the toner amounts of the respective end regions E of the plurality of sheets P, predicts the temperatures of non-passage regions according to a cumulative value (history value), and adjusts throughput. A specific value of temperature need not be estimated, and a value correlated to temperature may be estimated. Throughput is the number of sheets P to be subjected to fixing processing per unit time. However, the conveyance speed of a sheet P or a feeding interval between a succeeding sheet P and a preceding sheet P may also be understood as throughput.

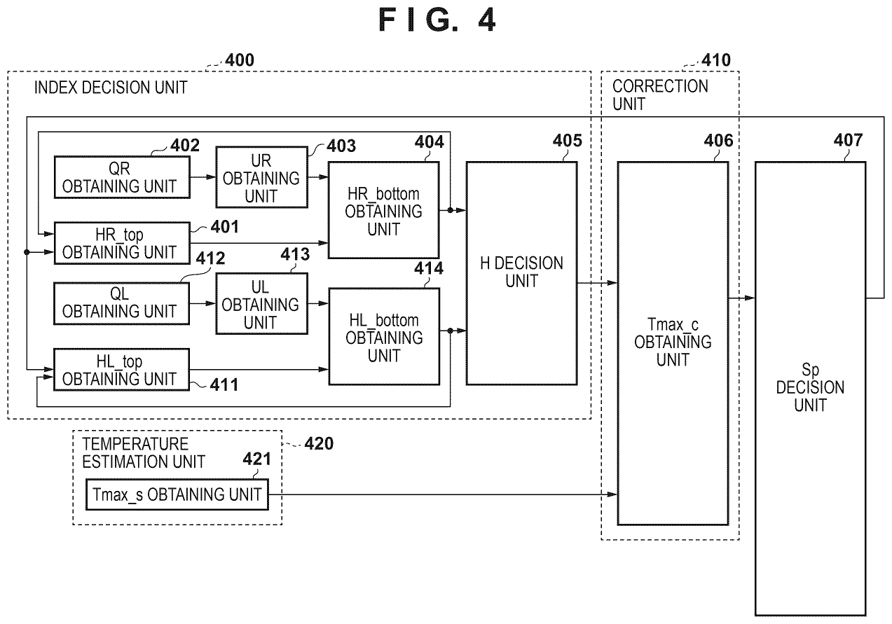

FIG. 4 illustrates functions realized by the CPU 41. An index decision unit 400 decides an index for decreasing the temperatures of non-passage regions NP in the fixing device 13. For example, this index increases as the amount of toner to be transferred to the end regions E of the sheet P increases. Further, indices, each obtained for a respective one of a plurality of sheets P that consecutively pass through the fixing device 13, are accumulated. Therefore, the index decision unit 400 may be referred to as an accumulation unit or a history unit. A temperature estimation unit 420 estimates the temperature of a non-passage region NP. A correction unit 410 corrects the temperature of a non-passage region NP estimated by the temperature estimation unit 420 by using the index decided by the index decision unit 400. With this, the temperature of a non-passage region NP can be accurately estimated. An Sp decision unit 407 decides throughput (e.g., a conveyance speed V and a feeding interval G) based on the temperature of a non-passage region NP. Further, in the first embodiment, the following physical amounts are defined. The feeding interval G may be referred to as a conveyance interval. The conveyance interval is a distance or time from the trailing end of a preceding sheet P to the leading end of a succeeding sheet P.

H is a cumulative value (history value) of the amount of toner transferred to an end region E. It is assumed that first to N-th sheets P consecutively pass through the fixing device 13. In this case, a history value H for when the leading end of the i-th sheet P arrives at the fixing device 13 is expressed as H_top. Further, a history value H for a right end region ER is expressed as HR. A history value H for a left end region EL is expressed as HL. Thus, R indicates a right region. L indicates a left region.

Q is the amount of toner that has been applied to an end region E of the i-th sheet P. QR is the amount of toner that has been applied to the end region ER of the i-th sheet P. QL is the amount of toner that has been applied to the end region EL of the i-th sheet P.

U is a saturation value of the amount of decrease in temperature (decrease capability) of the fixing film 14 due to the heat of the fixing film 14 being absorbed by toner on the sheet P. The higher the image printing ratio in the end region E, the larger the saturation value U. When the image printing ratio in the end region E is 0%, the saturation value U is 0. When the image printing ratio in the end region E is 100%, the saturation value U will assume a maximum value. UR is a saturation value for the right end region ER. UL is a saturation value for the left end region EL.

H_bottom is a history value H for when the trailing end of the i-th sheet P exits the fixing device 13. HR_bottom is a toner history for the right end region ER. HL_bottom is a toner history for the left end region EL.

Tmax_s is a temperature-related index in a non-passage region NP when there is no toner at all in an end region E. Tmax_s may be called a standard value or a reference value. This indicator may be referred to as a count for a temperature rise in a non-passage region. Tmax_c is an index related to the temperature in a non-passage region NP for when the i-th sheet P passes through the fixing device 13.

An HR_top obtaining unit 401 obtains HR_top for the i-th sheet P. When i is 1, HR_top is 0 (zero) because there is no preceding sheet P. When i is greater than or equal to 2, HR_top is decided according to H_bottom for a preceding sheet P and throughput (e.g., the feeding interval G). A QR obtaining unit 402 analyzes image data transmitted from a host computer or the like and thereby obtains the amount QR of toner to be used in the end region ER of the i-th sheet P. A UR obtaining unit 403 obtains the saturation value UR based on the toner amount QR. An HR_bottom obtaining unit 404 obtains HR_bottom based on HR_top and the saturation value UR.

An HL_top obtaining unit 411 obtains HL_top for the i-th sheet P. When i is 1, HL_top is 0 (zero) because there is no preceding sheet P. When i is greater than or equal to 2, HL_top is decided according to H_bottom for a preceding sheet P and throughput (e.g., the feeding interval G). A QL obtaining unit 412 analyzes image data transmitted from a host computer or the like and thereby obtains the amount QL of toner to be used in the end region EL of the i-th sheet P. A UL obtaining unit 413 obtains the saturation value UL based on the toner amount QL. An HL_bottom obtaining unit 414 obtains HL_bottom based on HL_top and the saturation value UL.

An H decision unit 405 decides a smaller history value H between HR_bottom and HL_bottom. That is, between HR_bottom and HL_bottom, one with a lower temperature decrease capability is selected. With this, the temperature of a non-passage region NP is less likely to be underestimated.

A Tmax_s obtaining unit 421 obtains a maximum temperature of the fixing film 14 for when M sheets P having no toner image in respective end regions ER and EL are consecutively inputted to the fixing device 13.

A Tmax_c obtaining unit 406 corrects the maximum temperature Tmax_s by using the history value H and thereby obtains the non-passage region temperature Tmax_c. The Sp decision unit 407 decides throughput (e.g., the feeding interval G) based on the non-passage region temperature Tmax_c. Throughput (e.g., the feeding interval G) affects the history value H. Therefore, throughput (e.g., the feeding interval G) is provided to the HR_top obtaining unit 401 and the HL_top obtaining unit 411.

### 1-5. Flowchart

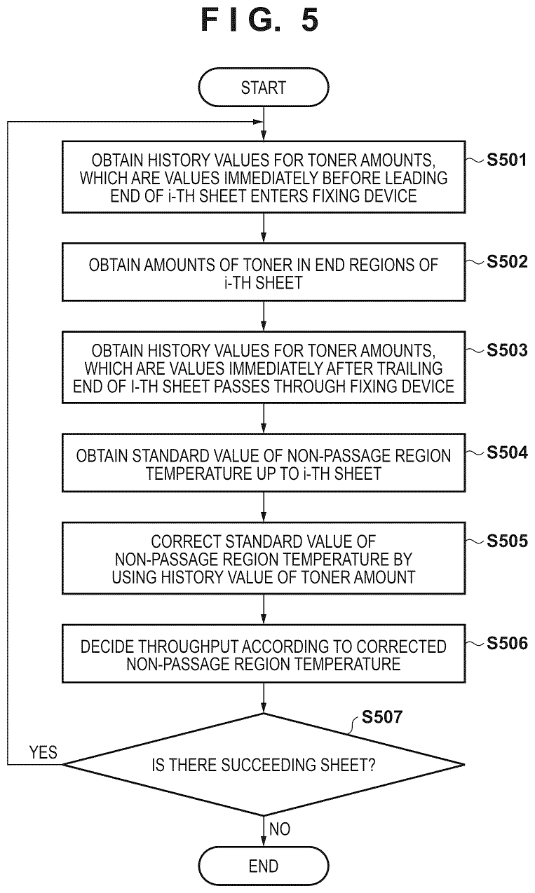

FIG. 5 illustrates a control method to be executed by the CPU 41 according to a control program. Here, when a plurality of sheets P are consecutively fed, throughput is adjusted taking into account, as a toner history (history value H), the amount of decrease in temperature of the fixing film 14 due to toner that has been applied to the end regions E. When a print signal is inputted into the image forming apparatus 1, the CPU 41 performs the following processing.

### Step S501: Obtain Leading End History Values

The CPU 41 (HR_top obtaining unit 401 and HL_top obtaining unit 411) obtains the history values HR_top and HL_top for toner amounts, which are values immediately before the leading end of the i-th sheet P enters the fixing device 13. The temperature of the fixing film 14 when a sheet P on which a toner image has not been formed is subjected to heat processing by the fixing device 13 is employed as a reference value. The history value H is a difference between the surface temperature of the fixing film 14 when a sheet P on which a toner image has been formed passes through the fixing device 13 and the reference value. This difference indicates the amount of decrease in temperature due to the toner image.

The i-th sheet P is a sheet P that is about to enter the fixing device 13. The preceding sheet is an i−1-th sheet P.

As described above, in the first embodiment, the history value HR_top for the end region ER and the history value HL_top for the end region EL are obtained. As illustrated in FIG. 3, the end region ER is a region of predetermined width (e.g., 10 mm) present at the right end of an A4-sized sheet P. The end region EL is a region of predetermined width (e.g., 10 mm) present at the left end of an A4-sized sheet P. When i=1, the history values HR_top and HL_top are set to their respective initial values (e.g., 0). When i is greater than or equal to 2, the history values HR_top and HL_top are decided according to the history values H obtained for the i−1-th sheet P.

### Step S502: Obtain Amounts of Toner Applied to End Regions

The CPU 41 (QR obtaining unit 402 and QL obtaining unit 412) obtains the amounts of toner in the end regions E of the i-th sheet P. For example, the CPU 41 calculates respective amounts QR and QL of toner in the end regions ER and EL from image information (position and density of an image) received from a host computer, an image scanner, or the like. Here, the toner amounts QR and QL are calculated for each sheet P. The toner amounts QR and QL may be the mass of toner or may be a ratio relative to the mass of toner in a reference condition. For example, an image in the reference condition is a toner image with a maximum density to be formed in an end region E (region that is 10 mm in width×297 mm in length) of an A4-sized sheet P. As one example, a toner amount in the reference condition is expressed as 250.

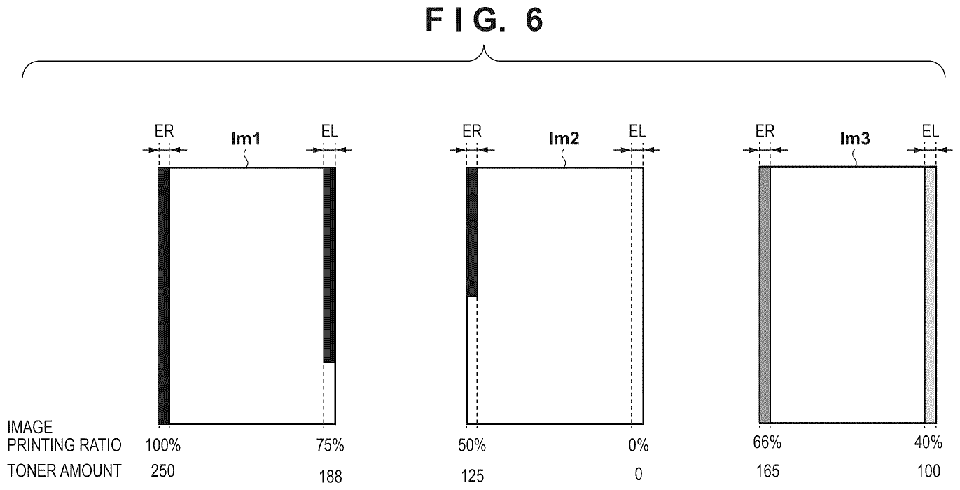

FIG. 6 illustrates examples of a toner amount. In the end region ER of an image Im1, a toner image is formed at an image printing ratio of 100%. The toner amount QR in this case is 250. In the end region EL of the image Im1, a toner image is formed at an image printing ratio of 75%. The toner amount QL in this case is 188.

In the end region ER of an image Im2, a toner image is formed at an image printing ratio of 50%. The toner amount QR in this case is 125. In the end region EL of the image Im2, a toner image is formed at an image printing ratio of 0%. The toner amount QL in this case is 0.

In the end region ER of an image Im3, a toner image is formed at an image printing ratio of 66%. The toner amount QR in this case is 165. In the end region EL of the image Im3, a toner image is formed at an image printing ratio of 40%. The toner amount QL in this case is 100.

### Step S503: Obtain Trailing End History Values

The CPU 41 obtains the history values HR_bottom and HL_bottom of toner amounts, which are values immediately after the trailing end of the i-th sheet P passes through the fixing device 13. For example, the history values HR_bottom and HL_bottom are calculated based on the toner amounts QR and QL, and the history values HR_top and HL_top, respectively. As described above, the UR obtaining unit 403 obtains the saturation value UR from the toner amount QR. The UL obtaining unit 413 obtains the saturation value UL from the toner amount QL. The saturation values U may be obtained from the following equations.

$$UR = c 1 \times QR \times QR + c 2 \times QR \qquad Eq1$$

$$UL = c 1 \times QL \times QL + c 2 \times QL \qquad Eq 2$$

Here, the coefficients c1 and c2 are obtained through experimentation or simulation. c1 is, for example, −0.000103. c2 is, for example, 0.0758.

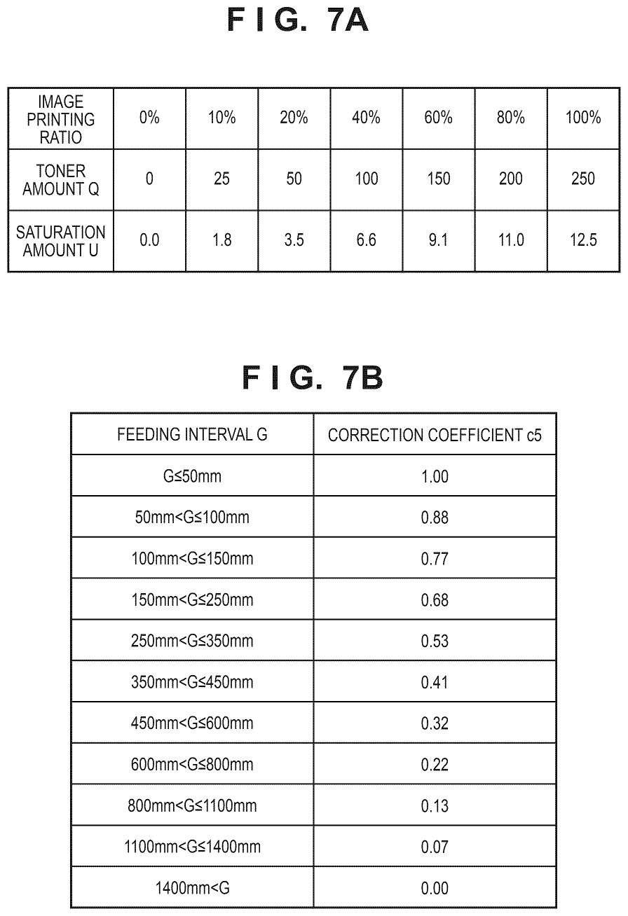

FIG. 7A illustrates an example of the saturation value U decided based on the toner amount Q. According to this example, the greater the toner amount Q, the greater the saturation value U. The greater the amount of toner carried on the sheet P, the greater the amount of heat absorbed from the fixing film 14 by the toner. That is, the greater the amount of toner, the greater the amount of decrease in surface temperature (saturation value).

Eq1 and Eq2 are equations approximating the amount of decrease in temperature of the fixing film 14 according to the first embodiment. However, Eq1 and Eq2 and the coefficients c1 and c2 are only one example. The coefficients c1 and c2 may be different values. Further, the equations themselves may be different.

The HR_bottom obtaining unit 404 and the HL_bottom obtaining unit 414 obtain the history values HR_bottom and HL_bottom based on the history values HR_top and HL_top and the saturation values UR and UL.

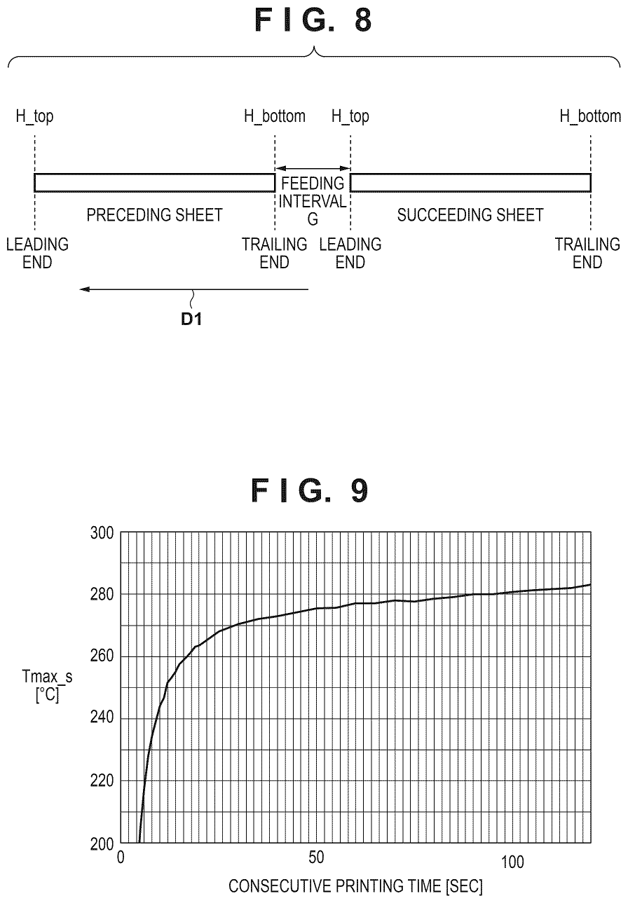

FIG. 8 illustrates timings at which the history values HR_top, HL_top, HR_bottom, and HL_bottom are obtained. The history values HR_bottom and HL_bottom may be calculated by the following equations.

$$HR\_bottom = HR\_top + ( UR - HR\_top ) \times c 3 \qquad Eq3$$

$$HL\_bottom = HL\_top + ( UL - HL\_top ) \times c 3 \qquad Eq 4$$

Here, the coefficient c3 is decided through experimentation or simulation. The coefficient c3 is, for example, 0.466.

The history value H_bottom for when the trailing end of the i-th sheet P passes through the fixing device 13 is obtained by adding the amount of decrease in temperature for the i-th sheet P to the history value H_top, which is a value before the i-th sheet P is subjected to heat processing by the fixing device 13. Here, the amount of decrease in temperature is obtained by multiplying a difference between the saturation value U and the history value H_top, which is a value before the i-th sheet P is subjected to heat processing in the fixing device 13, by the coefficient c3.

Eq3 and Eq4 and the value of the coefficient c3 are only one example. The coefficient c3 may be a different value. Further, the equations themselves may be different.

The H decision unit 405 decides a smaller value between the history value HR_bottom and the history value HL_bottom as the history value H of the i-th sheet P. By using a smaller history value H, a higher temperature between the temperature of the right non-passage region NPR and the temperature of the left non-passage region NPL is identified.

### Step S504: Obtain Standard Value of Passage Region Temperature

The CPU 41 (temperature estimation unit 420) obtains the standard value Tmax_s of non-passage region temperatures up to the i-th sheet P. The standard value Tmax_s is a maximum temperature of a non-passage region NP.

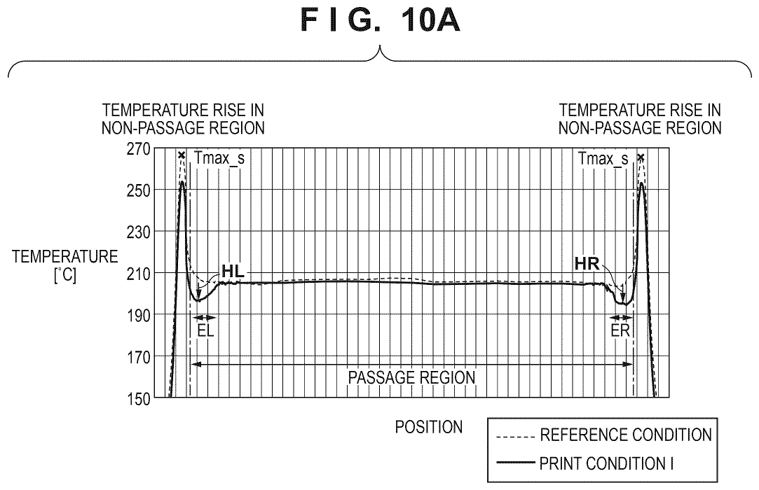

FIG. 9 illustrates a relationship between the standard value Tmax_s and consecutive printing time. Here, it is assumed that A4-sized sheets P, in which there are no toner images at all in both the end region ER and the end region EL, are consecutively conveyed at 43 sheets/min. A table indicating the relationship illustrated in FIG. 9 is stored in the ROM 42. Accordingly, the CPU 41 can obtain the standard value Tmax_s corresponding to consecutive printing time or the number of consecutively printed sheets by referring to this table. For example, when consecutive printing time is 30 seconds, Tmax_s is estimated to be 270° C. When consecutive printing time is 60 seconds, Tmax_s is estimated to be 277° C. An equation obtained by approximating the relationship illustrated in FIG. 9 may be used instead of the table.

### Step S505: Correct Non-passage Region Temperature

The CPU 41 (correction unit 410) corrects the non-passage region temperature standard value Tmax_s by using the history value H of the toner amount. With this, a corrected non-passage region temperature Tmax_c is obtained.

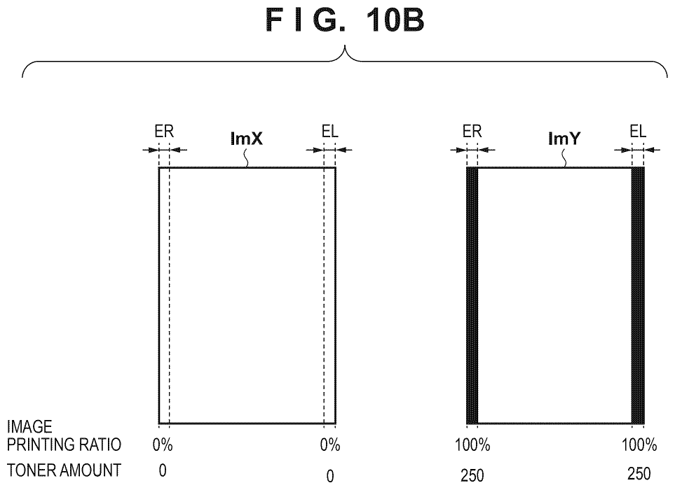

FIG. 10A illustrates a distribution of temperature of the fixing film 14 in the width direction. The vertical axis indicates the temperature. The horizontal axis indicates the position of the fixing film 14 in the width direction. The dashed line indicates a distribution of temperature distribution in the reference condition. As illustrated in FIG. 10B, in the reference condition, an image ImX is formed on the sheet P. Here, the image ImX is an image in which toner is not transferred to each of the end region ER and the end region EL of the sheet P (image printing ratio is 0%). The solid line indicates a distribution of temperature for a case where an image ImY is formed on the sheet P. Here, the image ImY is an image in which toner is applied to the end region ER and the end region EL of the sheet P (image printing ratio is 100%).

According to FIG. 10A, the temperature of the passage region is maintained at the target temperature (205° C.). However, the temperatures of the end regions ER and EL of the fixing film 14 for when the image ImY is formed on the sheet P is lower than the temperatures corresponding to the image ImX by the history values HR and HL.

Meanwhile, the temperatures of the non-passage regions NPR and NPL of the fixing film 14 corresponding to the image ImX are the standard value Tmax_s. The temperatures of the non-passage regions NPR and NPL of the fixing film 14 corresponding to the image ImY are temperatures lower than the standard value Tmax_s by the history values HR and HL. This is because the non-passage regions NPR and NPL of the fixing film 14 are in proximity to the end regions ER and EL of the sheet P. Accordingly, Tmax_s is corrected by the following equation.

$$Tmax\_c = Tmax\_s - c 4 \times H \qquad Eq5$$

Here, the coefficient c4 is, for example, 1.0. Thus, the CPU 41 may obtain the corrected non-passage region temperature Tmax_c by subtracting the correction value (c4× H) from the standard value Tmax_s. The coefficient c4 is merely one example and may be another value obtained by experimentation or simulation. For example, the coefficient c4 may be appropriately set according to the structure of the fixing device 13.

### Step S506: Adjusting Throughput

The CPU 41 (Sp decision unit 407) decides throughput according to the corrected non-passage region temperature Tmax_c. For example, the Sp decision unit 407 may determine whether the corrected non-passage region temperature Tmax_c exceeds a heat resistance threshold Tth (e.g., 265° C.) of the fixing film 14. If the non-passage region temperature Tmax_c exceeds the heat resistance threshold Tth, the Sp decision unit 407 decreases throughput. For example, if a normal throughput is 43 sheets/min, throughput may be decreased to 20 sheets/min. Throughput may be decreased by decreasing the conveyance speed V or by increasing the feeding interval G. If the non-passage region temperature Tmax_c does not exceed the heat resistance threshold Tth, the Sp decision unit 407 maintains or increases throughput. For example, if the current throughput is a normal throughput, the current throughput is maintained. If the current throughput is a decreased throughput, the current throughput is increased. With this, it is possible to increase the number of sheets to be processed (number of images to be formed) per unit time while protecting the fixing film 14.

In this example, two levels have been provided for throughput, but three or more levels may be provided. For example, if there are n levels, throughput can be adjusted according to n−1 thresholds.

### Step S507: Determine Print Completion

The CPU 41 compares the number of sheets to be printed instructed by the print job with the number of sheets P on which printing has been completed and thereby determines whether there is a succeeding sheet P. If there is no succeeding sheet P, the CPU 41 terminates the print job.

If there is a succeeding sheet P, the CPU 41 returns to step S501 from step S507. In the next step S501, the history values HR_top and HL_top for an i+1-th sheet P are calculated taking into account the history values HR_bottom and HL_bottom obtained for the i-th sheet P and throughput (e.g., the feeding interval G).

In the first embodiment, a black and white image is printed on one side of A4-sized (210 mm×297 mm) plain paper at a conveyance speed of 240 mm/sec (43 sheets/min). The feeding interval G is a normal feeding interval GO (e.g., 39 mm). However, the first embodiment may also be applied to double-sided printing. In double-sided printing, the feeding interval G may become longer than GO because a reversal operation for the sheet P is required. Further, the feeding interval G may become longer than GO due to feeding control, discharge control, or stacking control. In this case, the history value H_top of the i+1-th sheet P to be printed next is affected by the feeding interval G. Accordingly, the feeding interval G needs to be corrected according to Eq6 and Eq7.

$$HR\_top = HR\_bottom \times c 5 \qquad Eq6$$

$$HL\_top = HL\_bottom \times c 5 \qquad Eq7$$

FIG. 7B illustrates the correction coefficient c5 for the feeding interval G. Thus, the correction coefficient c5 is decided based on the feeding interval G between a preceding sheet P and a succeeding sheet P. The history value H_bottom represents the amount of decrease in temperature of the fixing film 14 due to toner. Since there is no sheet P passing through the fixing film 14 in a period corresponding to the feeding interval G, there is no toner acting on the fixing film 14. Accordingly, the history value H_top decreases toward the reference value (e.g., 0) when a sheet P on which a toner image is not formed is heated. As illustrated in FIG. 7B, the longer the feeding interval G, the smaller the correction coefficient c5. That is, the longer the feeding interval G, the smaller the history value H_top.

The normal feeding interval GO is 39 mm. The correction coefficient c5 in this case is 1.0. In this case, the history value H_top of the i+1-th sheet P is equal to the history value H_bottom of the i-th sheet P. The correction coefficient c5 indicated in FIG. 7B is only one example. The correction coefficient c5 may be appropriately decided by experimentation or simulation.

### 1-6. Effects of First Embodiment

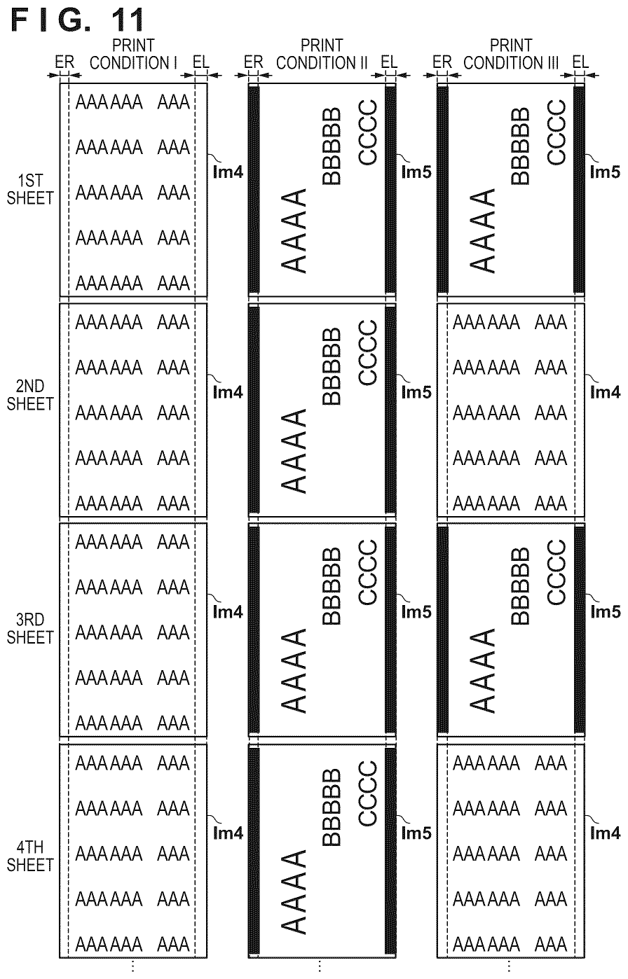

FIG. 11 illustrates print conditions I, II, and III employed to confirm the effects of the first embodiment. The print condition I is that in which an image Im4 is repeatedly printed onto a plurality of sheets P. The print condition II is that in which an image Im5 is repeatedly printed onto a plurality of sheets P. The print condition III is that in which the image Im4 and the image Im5 are alternatingly and repeatedly printed onto a plurality of sheets P. The feeding interval G is 30 mm for all the print conditions.

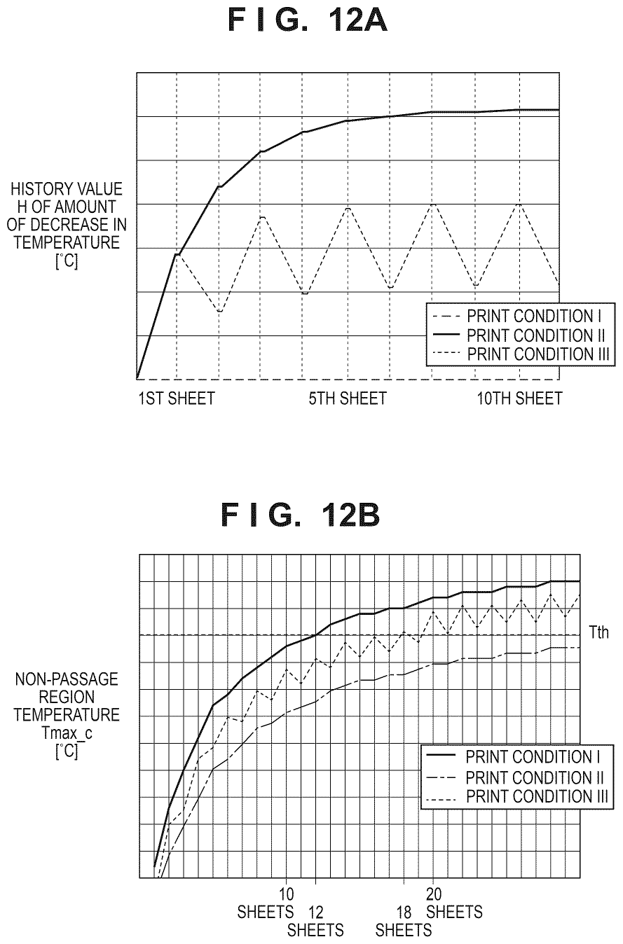

FIG. 12A illustrates transition of the history value H for each print condition. The vertical axis indicates the history value H. The horizontal axis indicates the number of printed sheets. In the print condition I, there is no toner image in the end regions ER and EL. Therefore, the history value His 0. In the print condition II, there is a toner image with an image printing ratio of 100% on the end regions ER and EL. Accordingly, the history value H increases as the number of printed sheets P increases. As a result, the history value H reaches 12.3 in the 10th sheet P. In the print condition III, the history value H varies but is 8.0 at its maximum.

FIG. 12B illustrates the non-passage region temperature Tmax_c for each print condition. The vertical axis indicates the non-passage region temperature. The horizontal axis indicates the number of printed sheets. In the print condition I, the non-passage region temperature Tmax_c increases as the number of printed sheets increases. When the number of printed sheets reaches 12, the non-passage region temperature Tmax_c exceeds the heat resistance threshold Tth (e.g., 265° C.). Accordingly, the feeding interval G is increased for the 13th and succeeding sheets P.

In the print condition II, when the number of printed sheets reaches 18, the non-passage region temperature Tmax_c exceeds the heat resistance threshold Tth. Accordingly, the feeding interval G is extended for the 19th and succeeding sheets P.

In the print condition III, even when the number of printed sheets reaches 30, the non-passage region temperature Tmax_c does not exceed the heat resistance threshold Tth. Accordingly, the feeding interval G is not changed, and a high throughput is maintained.

Thus, according to the first embodiment, the amounts (history values H) of toner transferred to the end regions ER and EL of a preceding sheet P is reflected in the history values H of toner amounts of a succeeding sheet P. That is, the non-passage region temperature for a succeeding sheet P is estimated or predicted taking into account the amount of decrease in non-passage region temperature due to toner in a preceding sheet P. As a result, a temperature rise in a non-passage region is appropriately suppressed while maintaining the number of sheets to be processed per unit time.

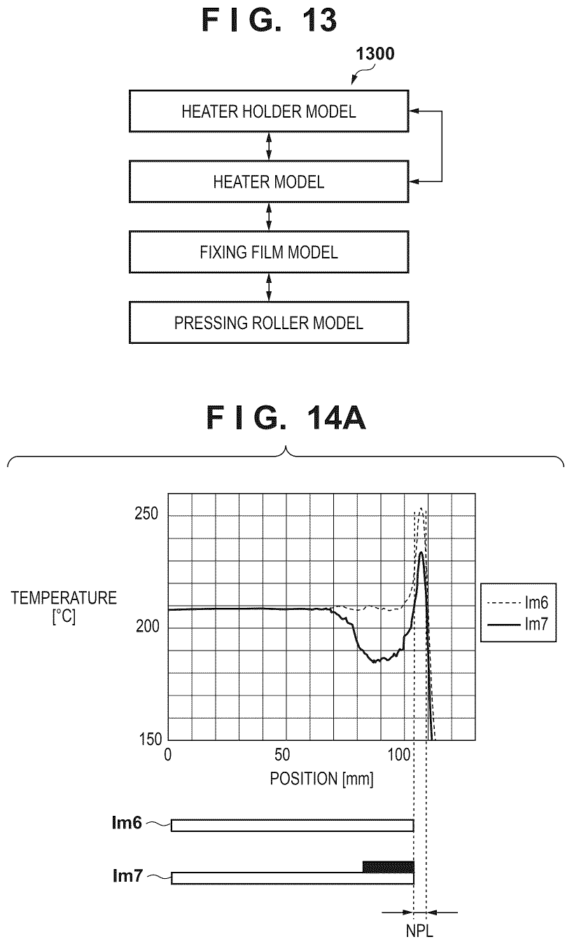

In the first embodiment, the temperature of a non-passage region is obtained according to the print time, but this is only one example. A non-passage region temperature of the fixing film 14 may be estimated using a heat propagation model 1300 illustrated in FIG. 13. The heat propagation model 1300 is a simplified representation of heat conduction between respective members constituting the fixing device 13. Arrows in FIG. 13 indicate a path of heat propagation between members in contact with each other. The CPU 41 may estimate a non-passage region temperature in real time by using the heat propagation model 1300. A program corresponding to the heat propagation model 1300 is stored in the ROM 42.

### 2. Second Embodiment

A second embodiment is a method of further controlling throughput taking into account the size of a sheet P. For example, if the length (width) of a sheet P in a direction orthogonal to a conveyance direction D1 of the sheet P is within a predetermined range, the throughput decision method described in the first embodiment is used. Meanwhile, if the width of a sheet P is small, throughput is decided using another method. The matters already described in the first embodiment will be omitted in the second embodiment.

### 2-1. Basic Concept

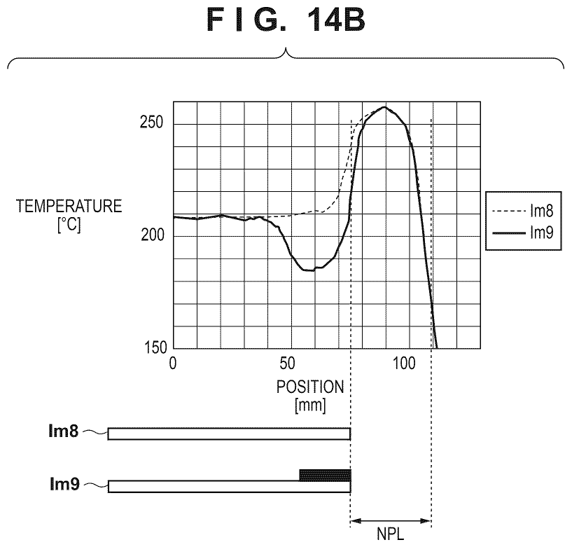

FIG. 14A illustrates transition of temperature of the non-passage region NPL for when printing is consecutively performed on an A4-sized (width L2=210 mm) sheet P. The vertical axis indicates the temperature. The horizontal axis indicates a distance (position) from the center of the fixing film 14. The center of the fixing film 14 is expressed as 0 mm. The solid line (image Im7) indicates transition of temperature for when a toner image is formed on the end region EL of a sheet P. The image printing ratio of the toner image in the end region EL is 100%. The dashed line (image Im6) indicates transition of temperature for when a toner image is not formed on the end region EL of a sheet P. The image printing ratio of the toner image in the end region EL is 0%.

According to FIG. 14A, a temperature rise in a non-passage region occurs at a position apart from the center of the fixing film 14 by about 105 mm to 110 mm. A position where the maximum temperature is reached is a position apart from the center of the fixing film 14 by about 107 mm to 108 mm. Regarding the image Im7, a toner image is formed in the end region EL of the sheet P. Further, a position where the toner image is formed is in proximity to the position where the maximum temperature is reached. Accordingly, the maximum temperature decreases due to the toner image. In particular, the maximum temperature for the image Im7 is lower than the maximum temperature for the image Im6 in which a toner image is not formed on the end region EL.

FIG. 14B illustrates transition of temperature of the non-passage region NPL for when printing is performed consecutively on an A5-sized (width L2=148 mm) sheet P. The vertical axis indicates the temperature. The horizontal axis indicates a distance (position) from the center of the fixing film 14. The center of the fixing film 14 is expressed as 0 mm. The solid line (image Im9) indicates transition of temperature for when a toner image is formed on the end region EL of a sheet P. The image printing ratio of the toner image in the end region EL is 100%. The dashed line (image Im8) indicates transition of temperature for when a toner image is not formed on the end region EL of a sheet P. The image printing ratio of the toner image in the end region EL is 0%.

In an A5-sized sheet P, a temperature rise in a non-passage region occurs at a position apart from the center of the fixing film 14 by about 74 mm to 110 mm. A position where the maximum temperature is reached is a position apart from the center of the fixing film 14 by about 90 mm. When the solid line and the dashed line are compared, it can be seen that the maximum temperature does not vary in an A5-sized sheet P regardless of whether there is a toner image in the end region EL.

Accordingly, it can be said that the width of a sheet P for which the first embodiment works effectively is 207 mm or more and 213 mm or less. Therefore, in the second embodiment, the control mode is switched according to the width of a sheet P.

### 2-2. Controller

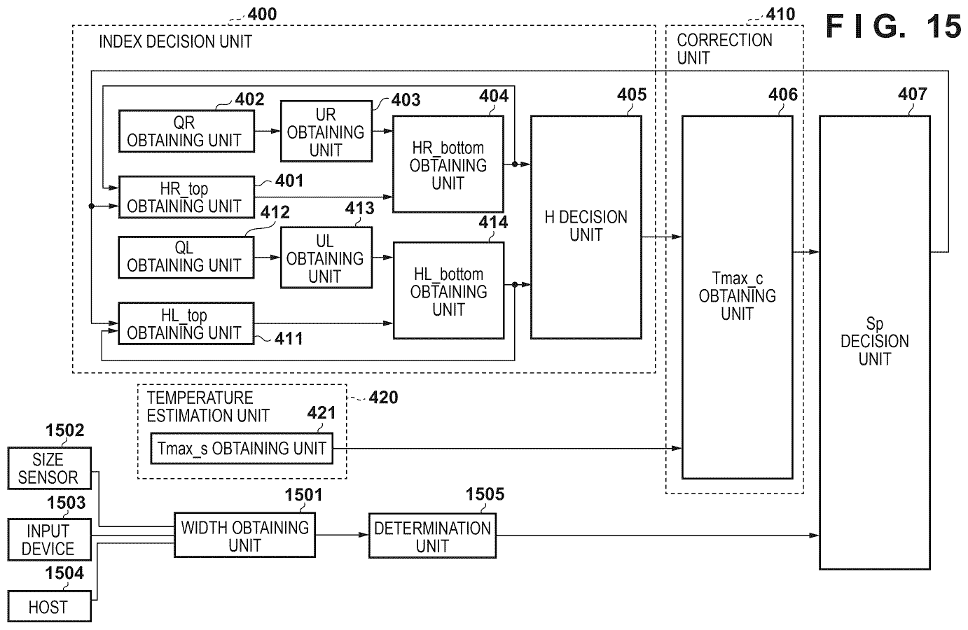

FIG. 15 illustrates functions realized by the CPU 41 of the second embodiment. Compared with the first embodiment, in the second embodiment, a width obtaining unit 1501 obtains the size (width) of a sheet P from a size sensor 1502 or an input device 1503 arranged in the image forming apparatus 1, or a host computer 1504. The size sensor 1502 is provided in the feeding cassette 21 or the conveyance path and is a sensor that detects the width of a sheet P. The input device 1503 is a touch sensor or an input key provided in an operation unit of the image forming apparatus 1. The user can specify the size of a sheet P through the input device 1503. The host computer 1504 is a computer that transmits a print job to the image forming apparatus 1. The host computer 1504 may specify the size of a sheet P through a printer driver. A determination unit 1505 determines whether the width of a sheet P is within a predetermined range (e.g., 207 to 213 mm) and outputs the determination result to the Sp decision unit 407. If the width of a sheet P is within the predetermined range, the Sp decision unit 407 decides throughput according to the technique described in the first embodiment. If the width of a sheet P is outside the predetermined range, the Sp decision unit 407 decides throughput according to another method. The other method includes, for example, deciding throughput according to the width of a sheet P. A table in which the width is associated with throughput may be stored in the ROM 42. The Sp decision unit 407 may obtain throughput (feeding interval G or conveyance speed V) corresponding to the width by referring to the table.

### 2-3. Flowchart

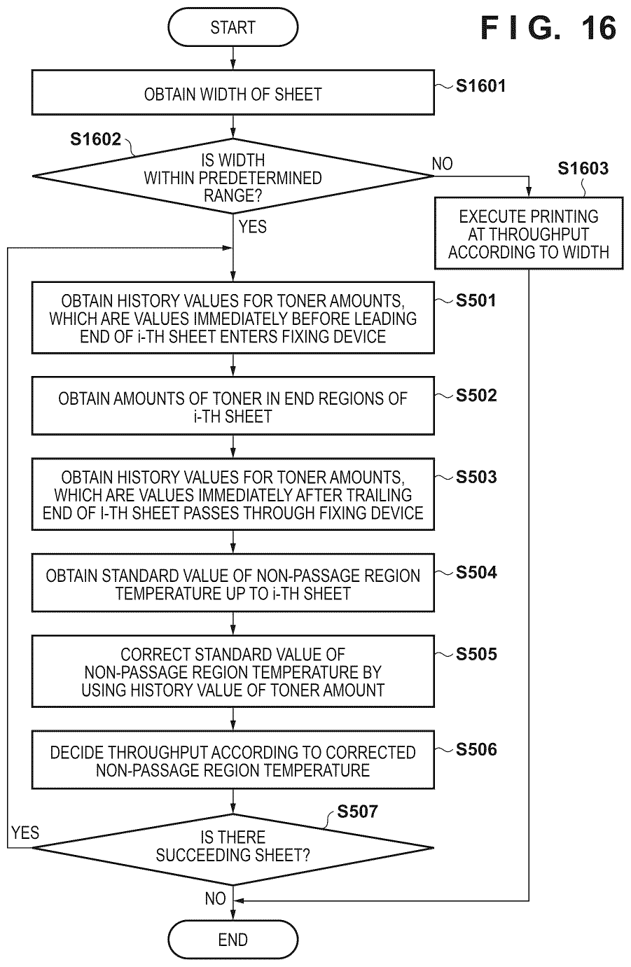

FIG. 16 illustrates a control method of the second embodiment. The CPU 41 executes the following processing according to a control program stored in the ROM 42.

In step S1601, the CPU 41 (width obtaining unit 1501) obtains the size (width) of a sheet P. Here, the width of a sheet P is the length of a sheet P in the lengthwise direction of the fixing film 14 (direction orthogonal to the conveyance direction D1).

In step S1602, the CPU 41 (determination unit 1505) determines whether the size of the sheet P (width) is within a predetermined range. If the size (width) of the sheet P is within a predetermined range, the CPU 41 advances the processing from step S1602 to step S501 and executes steps S501 to S507 in the control method described in the first embodiment. If the size (width) of the sheet P is not within the predetermined range, the CPU 41 advances the processing from step S1602 to step S1603.

In step S1603, the CPU 41 (Sp decision unit 407) decides throughput according to the width of the sheet P and executes printing with the decided throughput.

In the second embodiment, the control mode can be switched according to the width of a sheet P. For example, if the width of the sheet P is within the predetermined range, the control method described in the first embodiment is applied. As a result, the effects described in the first embodiment are achieved. Meanwhile, if the width of the sheet P is outside the predetermined range, a uniform throughput according to the width of the sheet P is applied. With this, the fixing film 14 is protected from heat, and the lifetime of the fixing device 13 is extended.

### 3. Third Embodiment

In the first embodiment, the temperature of a non-passage region NP is estimated based on the amounts of toner used in the end regions ER and EL of a sheet P in the width direction. A third embodiment is an improved version of the first embodiment, and the end regions ER and EL are further divided into a plurality of subregions, and the amount (history value H) of used toner is obtained for each subregion. With this, in the third embodiment, compared with the first embodiment, the accuracy of estimation of the temperature of a non-passage region NP is improved, and the accuracy of decision of throughput is improved. The matters already described in the first embodiment will be omitted in the third embodiment. That is, the description of the first embodiment is incorporated in the third embodiment.

### 3-1. Subregion

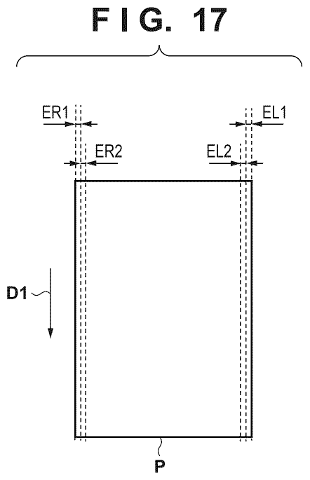

FIG. 17 illustrates subregions ER1, ER2, EL1, and EL2 of an A4-sized sheet P. Here, for convenience of explanation, the end region ER is divided into the subregions ER1 and ER2. The end region EL is divided into the subregions EL1 and EL2. Further, the end regions ER and EL may each be divided into three or more subregions.

The subregion ER1 is, for example, a region from the right end of a sheet P to a 5-mm point. The subregion ER2 is, for example, a region that starts at a position 5 mm from the right end of the sheet P and ends at a position 100 mm from the right end of the sheet P. Similarly, the subregion EL1 is, for example, a region from the left end of the sheet P to a 5-mm point. The subregion EL2 is, for example, a region that starts at a position 5 mm from the left end of the sheet P and ends at a position 100 mm from the left end of the sheet P.

For the subregions ER1, ER2, EL1, and EL2, respective history values HR1_top, HR2_top, HL1_top, and HL2_top are obtained. For the subregions ER1, ER2, EL1, and EL2, respective toner amounts QR1, QR2, QL1, and QL2 are obtained. Further, for the subregions ER1, ER2, EL1, and EL2, respective saturation values UR1, UR2, UL1, and UL2 are obtained. Further, for the subregions ER1, ER2, EL1, and EL2, respective history values HR1_bottom, HR2_bottom, HL1_bottom, and HL2_bottom are obtained.

The CPU 41 obtains the history value HR_bottom from the history values HR1_bottom and HR2_bottom. Further, the CPU 41 obtains the history value HL_bottom from the history values HL1_bottom and HL2_bottom.

$$HR\_bottom = c 6 \times HR1\_bottom + c 7 \times HR2\_bottom \qquad Eq8$$

$$HL\_bottom = c 6 \times HR1\_bottom + c 7 \times HL2\_bottom \qquad Eq9$$

For example, the coefficient c6 is 0.75. The coefficient c7 is 0.25. The coefficients c6 and c7 are decided by experimentation or simulation. The coefficients c6 and c7 indicate a contribution (temperature decrease capability) of a toner image formed in a subregion for decreasing the temperature of a non-passage region NP. A distance between the subregion ER1 and the non-passage region NPR is shorter than a distance between the subregion ER2 and the non-passage region NPR. Accordingly, the temperature decrease capability of a toner image formed on the subregion ER1 is higher than the temperature decrease capability of a toner image formed on the subregion ER2. Accordingly, the coefficient c6 is greater than the coefficient c7.

### 3-2. Controller

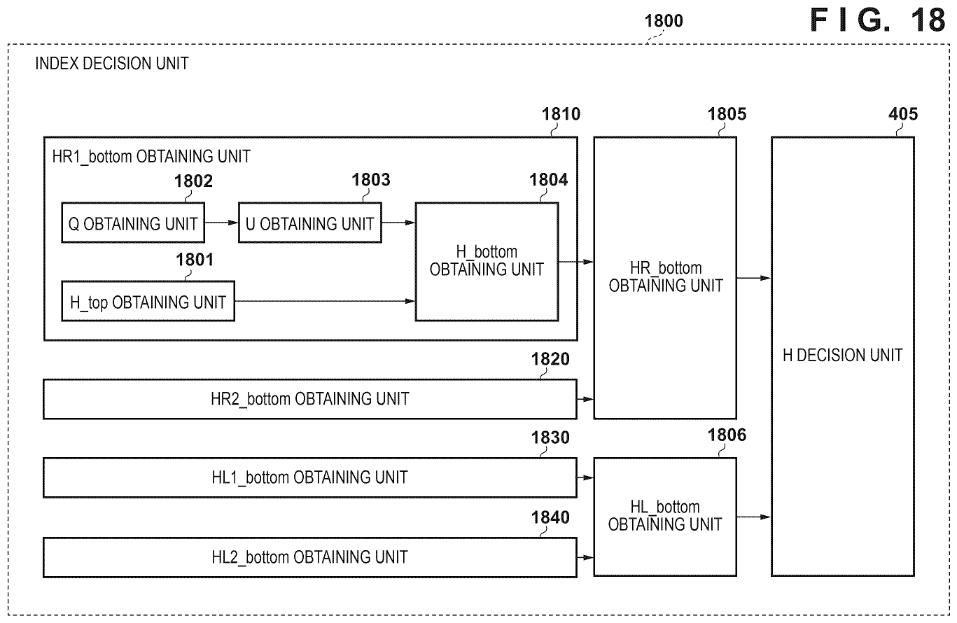

FIG. 18 illustrates an index determination unit 1800 of the third embodiment. The index determination unit 1800 replaces the index decision unit 400 and is used. An HR1_bottom obtaining unit 1810 obtains HR1_bottom for the subregion ER1. An HR2_bottom obtaining unit 1820 obtains HR2_bottom for the subregion ER2. An HL1_bottom obtaining unit 1830 obtains HL1_bottom for the subregion EL1. An HL2_bottom obtaining unit 1840 obtains HL2_bottom for the subregion EL2.

The internal configurations of the HR1_bottom obtaining unit 1810, HR2_bottom obtaining unit 1820, HL1_bottom obtaining unit 1830, and HL2_bottom obtaining unit 1840 are in common. Therefore, in FIG. 18, only the internal configuration of the HR1_bottom obtaining unit 1810 is illustrated.

An H_top obtaining unit 1801 obtains the history value H_top in the end region E. Specific operations of the H_top obtaining unit 1801 are similar to the operations of the HR_top obtaining unit 401 and the HL_top obtaining unit 411.

A Q obtaining unit 1802 obtains the toner amount Q in the end region E. Specific operations of the Q obtaining unit 1802 are similar to the operations of the QR obtaining unit 402 and the QL obtaining unit 412.

A U obtaining unit 1803 obtains the saturation value U in the end region E. Specific operations of the U obtaining unit 1803 are similar to the operations of the UR obtaining unit 403 and the UL obtaining unit 413.

An H_bottom obtaining unit 1804 obtains the history value H_bottom in the end region E.

An HR_bottom obtaining unit 1805 applies Eq8 to HR1_bottom outputted from HR1_bottom obtaining unit 1810 and HR2_bottom outputted from HR2_bottom obtaining unit 1820 and obtains HR_bottom.

An HL_bottom obtaining unit 1806 applies Eq9 to HL1_bottom outputted from the HL1_bottom obtaining unit 1830 and HL2_bottom outputted from the HL2_bottom obtaining unit 1840 and obtains HL_bottom.

The H decision unit 405 decides the history value H based on HR_bottom outputted from the HR_bottom obtaining unit 1805 and HL_bottom outputted from the HL_bottom obtaining unit 1806.

### 3-3. Flowchart

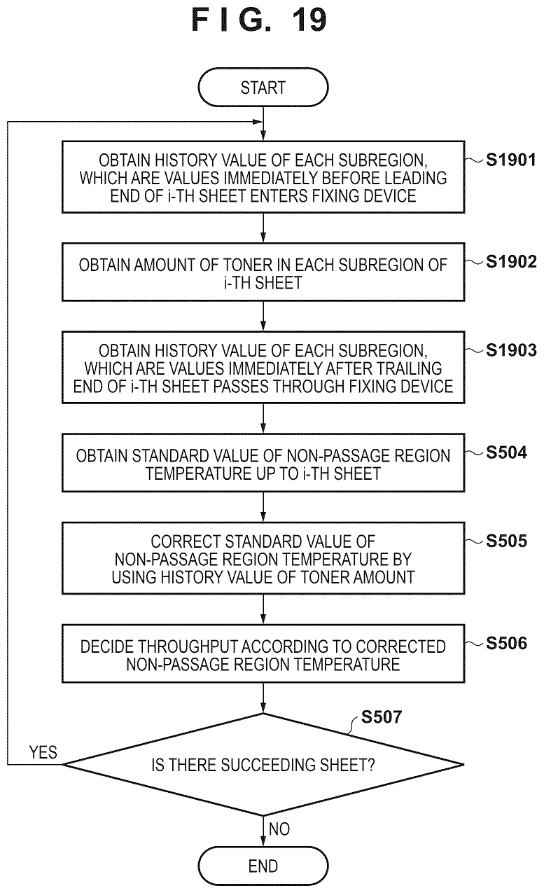

FIG. 19 illustrates a control method of the third embodiment. The processes in common with the control method of the first embodiment are given the same reference numerals, and the description thereof is incorporated in the third embodiment.

In step S1901, the CPU 41 (H_top obtaining unit 1801) obtains history values HR1_top, HR2_top, HL1_top, and HL2_top of toner amounts of respective subregions, which are values immediately before the leading end of the i-th sheet P enters the fixing device 13.

In step S1902, the CPU 41 (Q obtaining unit 1802) obtains the toner amounts QR1, QR2, QL1, QL2 in the subregions ER1, ER2, EL1, and EL2 of the i-th sheet P.

In step S1903, the CPU 41 (H_bottom obtaining unit 1804) obtains the history values HR_bottom and HL_bottom of toner amounts, which are values immediately after the trailing end of the i-th sheet P passes through the fixing device 13. First, the U obtaining unit 1803 obtains the saturation value U from the toner amount Q. The saturation value UR1 is obtained by substituting the toner amount QR1 into Eq1. The saturation value UR2 is obtained by substituting the toner amount QR2 into Eq1. The saturation value UL1 is obtained by substituting the toner amount QL1 into Eq2. The saturation value UL2 is obtained by substituting the toner amount QL2 into Eq2.

HR1_bottom is calculated by substituting HR1_top and UR1 into Eq3. HR2_bottom is calculated by substituting HR2_top and UR2 into Eq3. HL1_bottom is calculated by substituting HL1_top and UL1 into Eq4. HL2_bottom is calculated by substituting HL2_top and UL2 into Eq4.

Further, HR_bottom is calculated by substituting HR1_bottom and HR2_bottom into Eq8. HL_bottom is calculated by substituting HL1_bottom and HL2_bottom into Eq9. Subsequent processing is as described in the first embodiment.

In the third embodiment, the effects of the first embodiment can be achieved. Further, the third embodiment may control the throughput more accurately than the first embodiment and protect the fixing device 13.

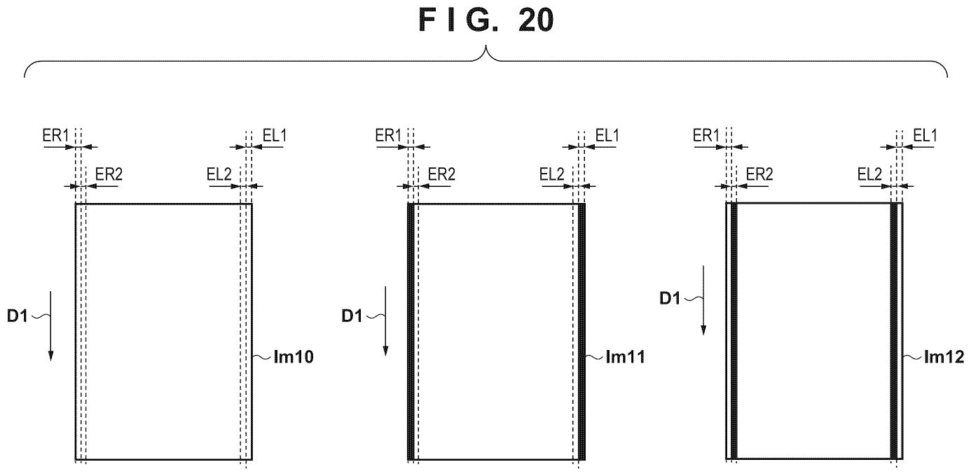

FIG. 20 illustrates test images Im10 to Im12 used to confirm the effects of the third embodiment. The test images Im10 to Im12 are all printed on an A4-sized sheet P. In the test image Im10, a toner image is not formed on the subregions ER1, ER2, EL1, and EL2. In the test image Im11, a black image (solid black) with a maximum density is formed on the subregions ER1 and EL1. In the subregions ER1 and EL1, a region from the leading end to a 5-mm point and a region from the trailing end to a 5-mm point are blank, and a toner image is not formed. The image printing ratio of the subregions ER1 and EL1 is 97%. The image printing ratio of the subregions ER2 and EL2 is 0%. In the test image Im12, a black image (solid black) with a maximum density is formed on the subregions ER2 and EL2. In the subregions ER2 and EL2, a region from the leading end to a 5-mm point and a region from the trailing end to a 5-mm point are blank, and a toner image is not formed. The image printing ratio of the subregions ER2 and EL2 is 97%. The image printing ratio of the subregions ER1 and EL1 is 0%.

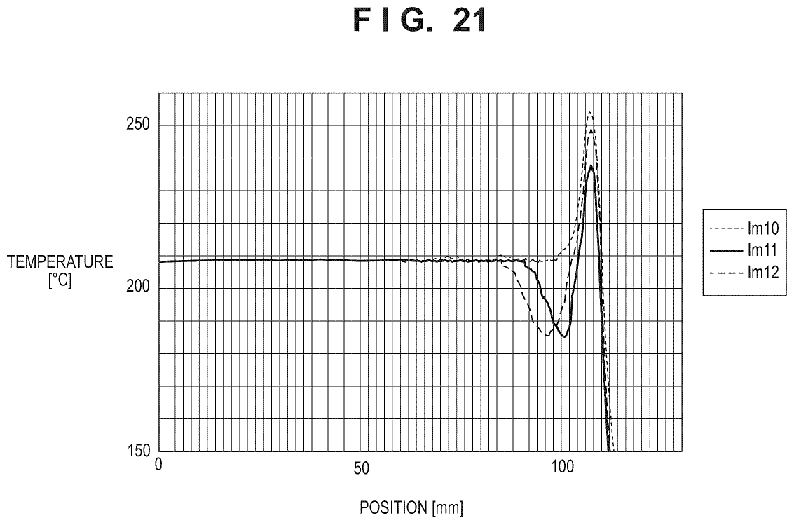

FIG. 21 illustrates transition of temperature of a non-passage region NPL for when test images Im10 to Im12 are each printed consecutively on K sheets P. Regarding the test image Im10, there is no toner image in the subregions EL1 and EL2. Therefore, the temperature of a non-passage region NPL is the highest.

Regarding the test image Im11, there is a toner image in the subregion EL1 but there is no toner image in the subregion EL2. The subregion EL1 is adjacent to the non-passage region NPL and thus is the most effect in decreasing the temperature of the non-passage region NPL.

Regarding the test image Im12, there is a toner image in the subregion EL2 but there is no toner image in the subregion EL1. The subregion EL2 is apart from the non-passage region NPL and thus is less effective in decreasing the temperature of the non-passage region NPL.

Thus, the end region E is divided into a plurality of subregions, and the history value H is obtained according to the distance from the end of the sheet P to each subregion and the toner amount of each subregion. As a result, the temperature of a non-passage region NP can be accurately obtained. As a result, it is possible to balance the improvement in throughput and the protection of the fixing device 13 at a high level.

The equations used in the third embodiment and their coefficients are only one example. Other equations and coefficients may be used. The variations described in the first embodiment are also applicable to the third embodiment. In addition, the third embodiment may be combined with the second embodiment. In this case, steps S501 to S503 described in FIG. 16 are replaced with steps S1901 to S1903.

### 4. Supplementation

The pressing roller 15 is an example of a first rotational member. The fixing film 14 is an example of a second rotational member. The heater 60 is an example of a heating unit. The controller 40 and the CPU 41 are examples of a control unit. In a sheet P, the end regions ER and EL each extend in parallel with the conveyance direction D1. According to the first to third embodiments, the number of sheets to be heated per unit time (number of images to be formed) is adjusted according to the history values H of the amounts of toner transferred to the end regions ER and EL. With this, a temperature rise in a non-passage region is appropriately suppressed while maintaining the number of sheets to be processed per unit time.

The heat resistance threshold Tth of the fixing film 14 is an example of an allowable temperature limit for the first rotational member.

The greater the amount of toner, the greater the amount of heat absorbed by the toner from the heater 60. When heat of a passage region adjacent to a non-passage region is absorbed by the toner, the temperature of the passage region decreases. Here, the heat propagates from the non-passage region to the passage region so as to maintain thermal equilibrium of the fixing film 14, and the temperature of the non-passage region also decreases. That is, the temperature of the non-passage region decreases depending on the amount of toner in the end region.

The end region may be divided into a plurality of subregions. The history value may be decided depending on the distance from the end to the subregion. With this, the temperature of the non-passage region is estimated more accurately.

H_bottom is an example of the history value for when the trailing end of the i-th sheet exits the nip portion. H_top is an example of history values accumulated from the first sheet to the i−1-th sheet. As suggested by Eq3 and Eq4, (U−H_top)×c3 is an example of a contribution to decrease in temperature of the end region E by the i-th sheet.

As suggested by Eq3 and Eq4, the coefficient c3 is an example of a first coefficient.

As suggested by Eq1 and Eq2, the coefficient c1 is an example of a second coefficient. The coefficient c2 is an example of a third coefficient.

As suggested by Eq6 and Eq7, H_bottom is an example of the history value at a timing when the trailing end of the i−1-th sheet passes through the nip portion. The coefficient c5 is an example of a fourth coefficient.

As described in relation to Eq5, the maximum temperature Tmax_s of the non-passage region NP for when the image printing ratio of the end region E is 0% is an example of the standard value.

By taking into account the width of the sheet P as described in the second embodiment, the temperature of the non-passage region NP can be estimated with more accuracy.

As described in the second embodiment, 207 mm or more and 213 mm or less is an example of the predetermined range.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-064117, filed Apr. 11, 2024 which is hereby incorporated by reference herein in its entirety.

What is claimed is:

1. An image forming apparatus comprising:
an image forming unit configured to form a toner image on a sheet;
a first rotational member;
a second rotational member configured to be in contact with the first rotational member and form a nip portion and configured to convey the sheet at a predetermined conveyance speed;
a heating unit configured to heat, via the first rotational member, the sheet on which the toner image has been formed; and
a control unit configured to control the number of sheets to be heated per unit time by the heating unit,
wherein the control unit is configured to obtain a history value of an amount of toner to be transferred to an end region of each of a plurality of sheets that are consecutively conveyed, the end region extending in parallel with a conveyance direction of the plurality of sheets, and adjust the number of sheets to be heated per unit time according to the history value.

2. The image forming apparatus according to claim 1, wherein
the control unit is configured to estimate, based on the history value, a temperature of a non-passage region through which the sheet does not pass in the nip portion and adjust the number of sheets to be heated per unit time such that the estimated temperature does not exceed an allowable temperature limit of the first rotational member.

3. The image forming apparatus according to claim 2, wherein
the control unit is configured to estimate the temperature of the non-passage region to be lower as the amount of toner indicated by the history value increases and estimate the temperature of the non-passage region to be higher as the amount of toner indicated by the history value decreases.

4. The image forming apparatus according to claim 3, wherein
the history value indicates a contribution to decrease in the temperature of the non-passage region by a toner image formed in the end region, and
the end region is divided into a plurality of subregions, and the contribution to decrease in the temperature of the non-passage region by a toner image formed in each of the plurality of subregions decreases as a distance from an end of the sheet to each subregion increases and increases as the distance decreases.

5. The image forming apparatus according to claim 2, wherein
the history value for when a trailing end of an i-th sheet among the plurality of sheets exits the nip portion is obtained based on:
the history value accumulated from a first sheet to the i−1-th sheet among the plurality of sheets, and
a contribution to decrease in temperature of the end region by the i-th sheet passing through the nip portion.

6. The image forming apparatus according to claim 5, wherein
the contribution is obtained by multiplying a difference between a saturation value of a temperature decrease amount for the non-passage region and the history value accumulated from the first sheet to the i−1-th sheet by a predetermined first coefficient.

7. The image forming apparatus according to claim 6, wherein
the saturation value is a sum of a first product obtained by multiplying a square of the amount of toner in the end region by a second coefficient and a second product obtained by multiplying the amount of toner in the end region by a third coefficient.

8. The image forming apparatus according to claim 5, wherein
the history value accumulated from the first sheet to the i−1-th sheet is obtained based on:
the history value at a timing when a trailing end of the i−1-th sheet passes through the nip portion, and
a fourth coefficient according to an interval from the trailing end of the i−1-th sheet and a leading end of the i-th sheet.

9. The image forming apparatus according to claim 2, wherein
the temperature of the non-passage region is estimated by subtracting the history value from a standard value of the temperature of the non-passage region.

10. The image forming apparatus according to claim 1, wherein
the control unit is configured to estimate, based on a width that is a length of the sheet in a direction orthogonal to the conveyance direction of the sheet and the history value, a temperature of a non-passage region through which the sheet does not pass in the nip portion and adjust the number of sheets to be heated per unit time such that the estimated temperature does not exceed an allowable temperature limit of the first rotational member.

11. The image forming apparatus according to claim 10, wherein
the control unit is configured to:
in a case where the width is within a predetermined range, estimate the temperature of the non-passage region based on the history value and adjust the number of sheets to be heated per unit time according to the temperature of the non-passage region, and
in a case where the width is not within the predetermined range, adjust the number of sheets to be heated per unit time according to the width.

12. The image forming apparatus according to claim 1, wherein
the number of sheets to be heated per unit time is increased as the history value increases and is decreased as the history value decreases.

13. The image forming apparatus according to claim 5, wherein
the control unit is configured to obtain, for each of a first end region along a first side in parallel with the conveyance direction of the sheet and a second end region along a second side in parallel with the conveyance direction of the sheet among four sides of the sheet, the history value and adjust, based on a smaller history value among the history value of the first end region and the history value of the second end region, the number of sheets to be heated per unit time.

14. The image forming apparatus according to claim 1, wherein
the number of sheets to be heated per unit time is adjusted by changing a conveyance interval between a preceding sheet and a succeeding sheet.

15. The image forming apparatus according to claim 1, wherein
the number of sheets to be heated per unit time is adjusted by changing a conveyance speed of the sheet.
